(19) United States
(12) Patent Application Publication
(10) Pub. No.: US 2026/0055817 A1
(43) Pub. Date: Feb. 26, 2026

(54) CONTROL VALVE AND MANIFOLD COVER FOR SAME

(71) Applicant: A. O. Smith Corporation, Milwaukee, WI (US)

(72) Inventor: David James Widener, Milwaukee, WI (US)

(21) Appl. No.: 18/813,844

(22) Filed: Aug. 23, 2024

(51) Int. Cl. F16K 5/04; C02F 5/00

(52) U.S. Cl. CPC F16K 5/0492; C02F 5/00; C02F 2201/005

(57) ABSTRACT

A control valve includes a body, a supply water inlet port, a first media tank port in communication with a top of a media tank, a second media tank port in communication with a bottom of the media tank, and a manifold cover removable from the body and defining a plug, an injector, and an indicium located on an exterior of the manifold cover, the manifold cover couplable to the body in a first orientation and in a second orientation, distinct from the first orientation. In the first and second orientations, the injector is positioned in a flow path between the supply water inlet port and one of the media tank ports and the plug closes a flow path between the supply water inlet port and the other media tank port. The indicium identifies an orientation of the manifold cover relative to the body.

### BACKGROUND

Water softener control valves operate to direct a flow of pressurized water through a water softener system in various operating modes. These modes can include (among others): a service mode, in which the pressurized source water is directed to flow through a softening media tank and then to a plumbing system; a fill mode, in which the pressurized source water is directed to a regenerant (e.g. brine) tank in order to fill that tank with brine water; a brining mode, in which the pressurized source water is used as a motive flow to draw the brine water out of the regenerant tank and through the softening media tank in order to regenerate the softening media; a backwashing mode, in which the pressurized source water is directed to flow in a reverse direction through the softening media tank and then to a waste drain; and a rinse mode, in which the pressurized source water is directed to flow in a forward direction through the softening media tank and then to a waste drain.

In some cases, it may be desirable for the brining of the media tank to occur with a downward flow direction through the softening media tank, referred to as “downflow brining”. In other cases, it may be desirable for the brining of the media tank to occur with an upward flow direction through the softening media tank, referred to as “upflow brining”. Some valves (such, as for example, the WS1 Control Valve from Clack Corporation of Windsor, Wisconsin) can be configured to operate in either a downflow brining mode or upflow brining mode, in order to address these varying needs. However, it is typically difficult or impossible to determine the brining mode that such a valve has been configured to without disassembling the valve. This can be cumbersome and time-consuming for personnel who are installing, troubleshooting, or servicing such a water softening system.

### SUMMARY

In some aspects, the techniques described herein relate to a control valve operable to direct a flow of pressurized water through a water treatment system (for example, a water softener system) having a media tank, the control valve including: a body; a supply water inlet port through which a flow of supply water is configured to enter the body; first media tank port in communication with a top of the media tank; a second media tank port in communication with a bottom of the media tank; and a manifold cover removable from the body and defining a plug, an injector, and an indicium located on an exterior of the manifold cover, the manifold cover couplable to the body in a first orientation and in a second orientation, distinct from the first orientation, wherein, in the first orientation, the injector is positioned in a flow path between the supply water inlet port and the first media tank port and the plug closes a flow path between the supply water inlet port and the second media tank port, and wherein, in the second orientation, the injector is positioned in the flow path between the supply water inlet port and the second media tank port and the plug closes the flow path between the supply water inlet port and the first media tank port, wherein the indicium identifies an orientation of the manifold cover relative to the body.

In some aspects, the techniques described herein relate to a control valve operable to direct a flow of pressurized water through a water treatment system having a media tank, the control valve including: a body; a supply water inlet port through which a flow of supply water is configured to enter the body; first media tank port in communication with a top of the media tank; a second media tank port in communication with a bottom of the media tank; and a manifold cover removable from the body and defining a plug and an injector fixedly coupled to one another, the manifold cover couplable to the body in a first orientation and in a second orientation, distinct from the first orientation, wherein, in the first orientation, the injector is positioned in a flow path between the supply water inlet port and the first media tank port and the plug closes a flow path between the supply water inlet port and the second media tank port, and wherein, in the second orientation, the injector is positioned in the flow path between the supply water inlet port and the second media tank port.

In some aspects, the techniques described herein relate to a manifold cover of a control valve operable to direct a flow of pressurized water through a water treatment system having a media tank, the manifold cover including: an upper cover portion having an exterior surface; at least one plug extending from and fixedly coupled to the upper cover portion, each plug of the at least one plug configured to close a flow path when received within the control valve; an injector extending from and fixedly coupled to the upper cover portion, the injector configured to provide a flow path when received within the control valve; wherein the injector and the at least one plug have similar diameters such that, in a first orientation, the injector is sealingly receivable within a first opening of the control valve and a plug of the at least one plug is sealingly receivable within a second opening of the control valve, and, in a second orientation, the injector is sealingly receivable within the second opening of the water softener control valve and a plug of the at least one plug is sealingly receivable within the first opening of the control valve.

### BRIEF DESCRIPTION OF THE DRAWINGS

FIG. 1 is a cross-sectional view of a water softener control valve according to the prior art.

FIG. 2 is a perspective view of a piston assembly and spacer stack assembly of the water softener control valve of FIG. 1.

FIG. 3 is a cross-sectional view of the water softener control valve of FIG. 1, illustrating flow paths during a downflow brining operation.

FIG. 4 is a cross-sectional view of the water softener control valve of FIG. 1, illustrating flow paths during an upflow brining operation.

FIG. 5 is a schematic representation of a water softener system having a control valve according to an embodiment.

FIG. 6 is a schematic representation of a water softener system having a control valve according to another embodiment.

FIG. 7 is an exploded perspective view of a body, manifold cover, and lock of the control valve of FIG. 6.

FIG. 8 is a cross-sectional view of the body, manifold cover, and lock of the control valve of FIG. 6.

FIG. 9 is a front view of the body, manifold cover, and lock of the control valve of FIG. 6.

FIG. 10 is a rear view of the body, manifold cover, and lock of the control valve of FIG. 6.

FIG. 11 is a perspective view of a manifold cover according to another embodiment.

FIG. 12 is a perspective view of the manifold cover of FIG. 11 with a body and lock of the control valve.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling.

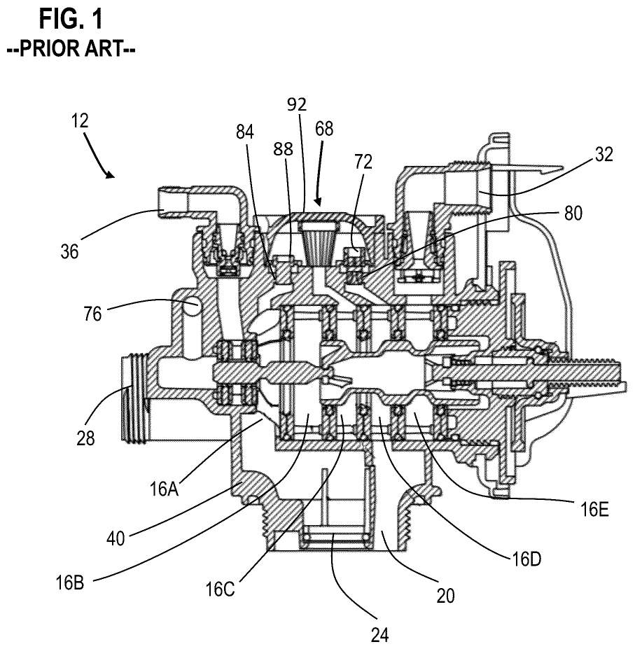

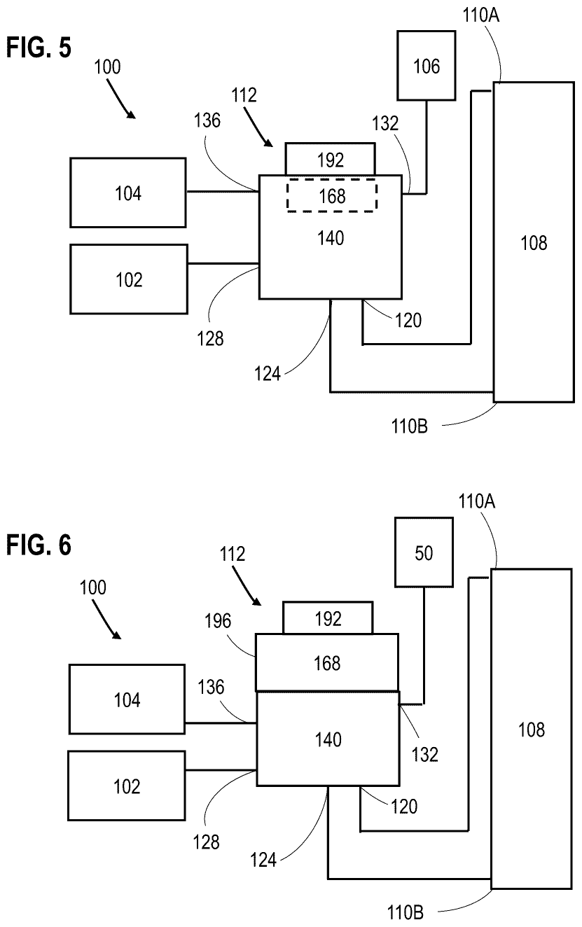

FIG. 1 illustrates a water softener control valve 12 according to the prior art. The valve 12 has a series of five chambers 16A, 16B, 16C, 16D, 16E (i.e., 16A-16E) defined within a valve body 40 that are in fluid communication with various inlet and outlet ports (depending upon an operational mode of the valve 12), which can in turn be coupled to other components of a water softening system in order to operate the system. The first chamber 16A is in communication with a second media tank port 24 of the valve 12 that connects to a bottom end of a media tank (FIGS. 5-6) (e.g., by connecting to a riser tube that extends down through softening media contained within the tank). The second chamber 16B is in communication with an outlet port (not shown, out of plane of the cross-section of FIG. 1) that provides softened water from the system. The third chamber 16C is in communication with a supply water inlet 28, through which unsoftened supply water is received into the body 40 of the valve 12 from a pressurized water source. The fourth chamber 16D is in communication with a first media tank port 20 of the valve 12 that connects to a top end of the media tank (FIGS. 5-6). The fifth chamber 16E is in communication with a wastewater drain port 32. The valve 12 is further provided with a regenerant inlet 36 that is coupled to a salt or brine tank (FIGS. 5-6).

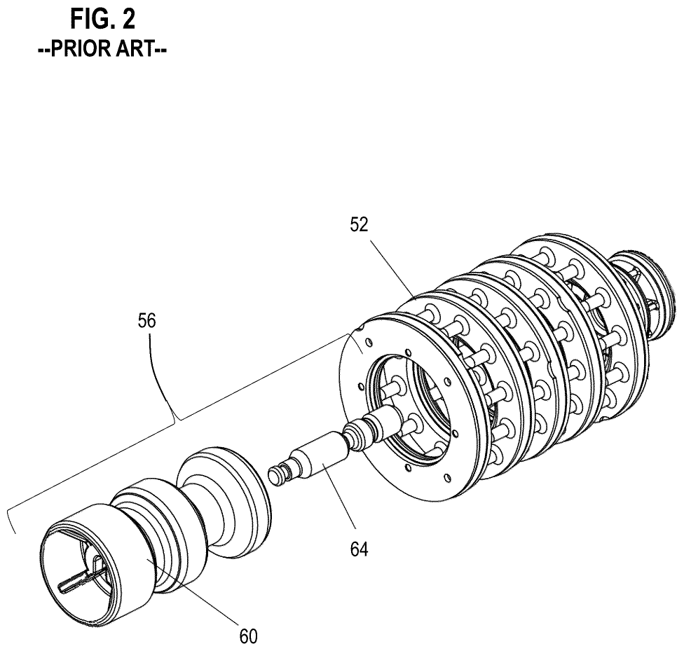

As shown in greater detail in FIG. 2, the five chambers 16A-16E are at least partially defined by a spacer stack assembly 52 that is inserted into a central bore of the valve body 40. A piston 56 having a main piston portion 60 and a regenerant piston portion 64 is axially driven within the spacer stack assembly 52 by a drive motor (not shown), and surfaces of the piston sealingly engage seals of the spacer stack assembly 52 in order to place certain ones of the chambers 16A-16E in fluid communication with one another.

During normal (i.e., “service”) operation of the water softening system, the piston 56 is arranged within the spacer stack assembly 52 such that supply water is directed from the supply water inlet 28 to the top of the media tank (FIGS. 5-6). The supply water travels down through the softening media in the tank, and mineral ions such as calcium and magnesium (referred to as “hard water” minerals) are removed from the supply water by the softening media and replaced by sodium ions. The now-softened water is then drawn from the bottom of the media tank back into the valve 12 and is directed to the outlet port (not shown). Over time, the softening media becomes depleted of the sodium ions, and must be regenerated. The regeneration process typically includes a series of stages, including backwashing of the media bed, filling of the brine tank with water to create a brine solution, brining the softening media with the brined solution to replace the hard water ions with sodium ions, and rinsing of the media bed. These stages are performed through the translation of the piston 56 within the spacer stack assembly.

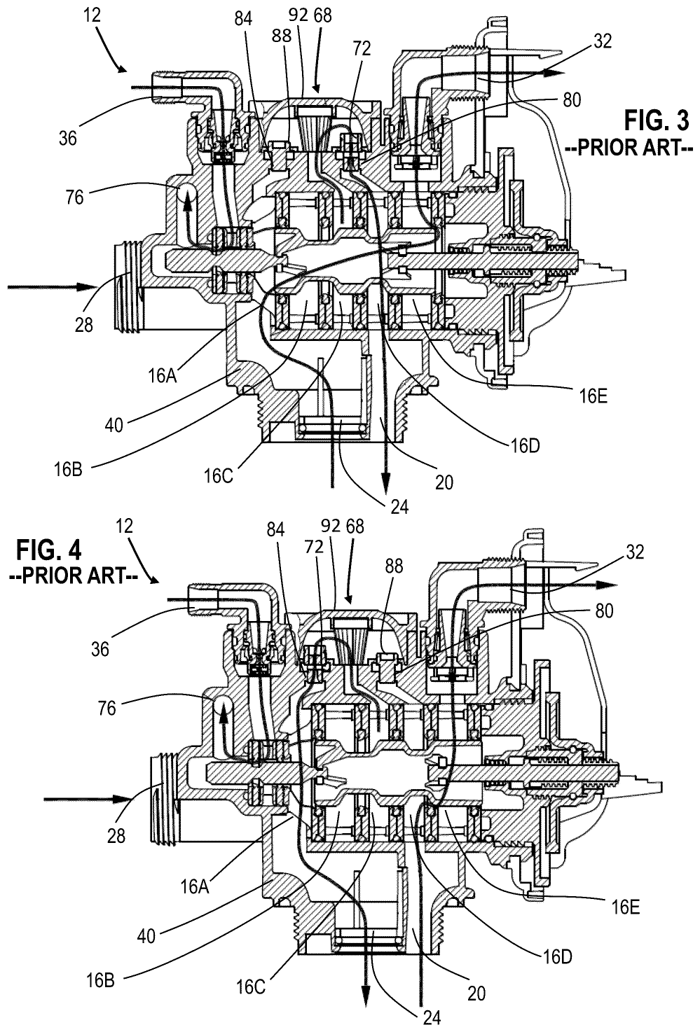

During the brining operation, supply water flows from the third chamber 16C (which is connected to and receives the supply water from the supply water inlet port 28) to an injector manifold 68, and then through an injector 72 to the media tank. The manifold 68 is defined by a manifold body having a manifold cover 92. The flow of the pressurized feed water through the injector 72 siphons brine from the brine tank (FIGS. 5 and 6) through the regenerant inlet 36 of the valve 12 and through a passage 76 of the valve 12 that terminates in the injector manifold 68 (out of plane in the cross-section of FIG. 1). The regenerant inlet 36 is placed in fluid communication with the injector 72 through the passage 76 by the positioning of the regenerant piston portion 64 of the piston 56. The mixed brine and supply water flows through the softening media in the tank to regenerate the media and is subsequently directed to the waste drain 32. In some applications, it is desirable for this regeneration to occur by having the solution flow through the media in a top-to-bottom direction, referred to as “downflow brining.” FIG. 3 illustrates the control valve 12 configured for downflow brining, and the resultant flow (indicated by the arrow lines) through the valve 12 during the brining operation. Downflow brining is accomplished by directing the solution flow from the injection manifold 68 through the injector 72 to the fourth chamber 16D (which is in communication with the top of the tank via the first media tank port 20), and having the solution subsequently flow from the first chamber 16A (which is in communication with the bottom of the tank via the second media tank port 24) to the drain 32. Conversely, in other applications, it is desirable for this regeneration to occur by having the solution flow through the media in a bottom-to-top direction, referred to as “upflow brining.” FIG. 4 illustrates the control valve 12 configured for upflow brining, and the resultant flow (indicated by the arrow lines) through the valve 12 during the brining operation. Upflow brining is accomplished by directing the solution flow from the injection manifold 68 through the injector 72 to the first chamber 16A and the second media tank port 24, and having the solution subsequently flow from the first media tank port 20 to the fourth chamber 16D and subsequently to the drain 32. In order to accommodate both types of applications, the valve body 40 is provided with a first port 80 that communicates between the injector manifold 68 and the fourth chamber 16D, and a second port 84 that communicates between the injector manifold 68 and the first chamber 16A. The valve 12 can be configured for downflow brining by placing the injector 72 in the first port 80 and a plug 88 (to block any flow) in the second port. Conversely, the valve 12 can be configured for upflow brining by placing the injector 72 in the second port 84 and the plug 88 in the first port 80.

As seen in FIGS. 1-4, the configuration of the valve 12 can be changed from upflow brining to downflow brining, or vice-versa, by removing the manifold cover 92 and switching the port locations for the plug 88 and injector 72. However, with the cover 92 in place, the brining direction for which the valve 12 is configured is not readily apparent. Furthermore, even with the manifold cover 92 removed it can be challenging for a user, installer, service personnel, etc. to know which injector and plug placement is the correct one to achieve the desired valve configuration.

FIG. 5 illustrates a water softener system 100 having a water softener control valve 112, similar to the water softener control valve 12, except as otherwise described. The valve 112 includes a valve body 140 that receives supply water from a supply water source 102 through a supply water inlet port 128 and receives regenerant (e.g., brine) from a regenerant tank 104 through a regenerant inlet 136. A first media tank port 120 of the valve 112 is coupled to a top end 110A of the brine tank 108 and a second media tank port 124 of the valve 112 is coupled to a bottom 110B of the brine tank 108. A wastewater drain port 132 of the valve 112 directs fluid to a drain 106. A manifold cover 192, described in greater detail with respect to FIGS. 6-8, is coupled to the valve body 140. In the embodiment shown in FIG. 5, the manifold cover 192 is coupled directly to the valve body 140, with a body of an injector manifold 168 (associated with the manifold cover) formed integrally within and at least partially defined by the valve body 140. With reference to FIG. 6, in other embodiments, the injector manifold 168 has a manifold body 196 that is separate and attachable and, in some embodiments, removable from the valve body 140.

FIGS. 6-8 illustrate the injector manifold 168 as being separate from the valve body 140. While shown as a stand-alone component, it should be understood that the injector manifold 168 can alternatively be integrated into the control valve body 140, as shown in FIG. 5, and similar to how the injector manifold 68 is integrated into the control valve body 40 in FIG. 1. In view of the above, the term “body” (rather than “valve body” or “manifold body”) is used to refer to the manifold body 196 and/or the valve body 140 (i.e., if the manifold body is integrated into the valve body 140). Description of interaction of the manifold cover 192 with the manifold body 196 in the description of FIGS. 6-12 is understood to be descriptive of interaction of the manifold cover 192 with the valve body 140 when the manifold body 196 is incorporated into the valve body 140.

The injector manifold 168 includes multiple ports. A first port is a supply water inlet port 200 and is in communication with the supply water (for example, by a third chamber, similar to the third chamber 16C of the valve 12). A second port is a regenerant inlet 204 and is in communication with the regenerant inlet. A third port 208 is in communication with the top 110A of the media tank 108 (for example, by the fourth chamber, similar to the fourth chamber 16D of the valve 12) and a fourth port 212 is in communication with the bottom 110B of the media tank 108 (for example, by a first chamber, similar to the first chamber 16A of the valve 12). In the embodiment shown in FIGS. 6-10, the ports 200, 204, 208, 212 are formed in and by the manifold body 196. In the embodiment shown in FIG. 5, in which the injection manifold is formed integrally with the valve body 140, the ports 200, 204, 208, 212 may be located internally within the valve body 140 or may otherwise correspond to the external ports 128, 136, 124, 120, respectively, of the valve body 140.

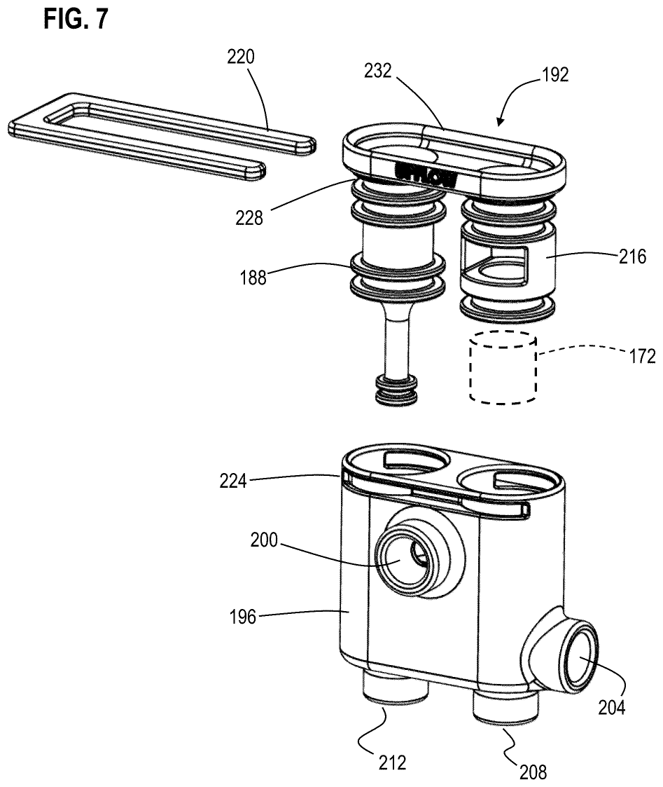

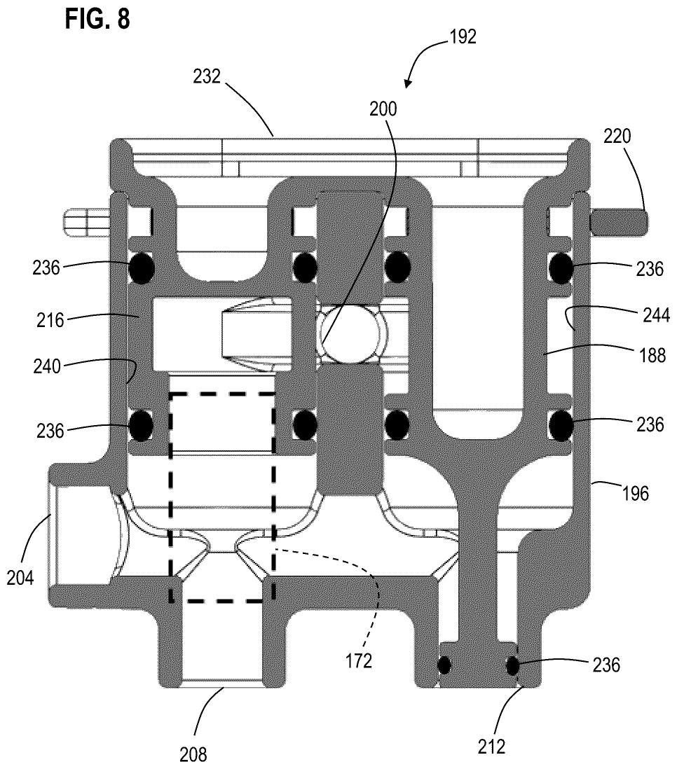

With continued reference to FIG. 7, the manifold cover 192 of the injector manifold 168 includes an integrated plug 188, and an injector 172 (illustrated with dashed lines) that is assembled to the cover 192. As shown, the cover 192 includes a sleeve 216 that receives the injector 172 such that the plug 188 and the injector 172 are fixedly coupled to one another such that removal of the manifold cover 192 from the body 196 simultaneously removes the plug 188 and the injector 172 from the body 196. The sleeve 216 extends downward from an upper cover portion 232 of the manifold cover 192 parallel to and spaced apart from the plug 188. Each of the plug 188 and the sleeve 216 include a plurality of radially extending protrusions spaced apart in pairs to receive seals such as O-rings 236 (FIG. 8) therebetween. The O-rings 236 on the cover 193 are removed for clarity in FIG. 7. The manifold cover 192 accommodates the injector 172 and plug 188 into a single unit that is movable, insertable, and removable as one piece.

A lock 220, as shown a sliding lock, is used to secure the cover 192 to the injector manifold 168. As shown, the lock 220 is a generally U-shaped lock having two legs extending parallel to one another from a base, each leg terminating at an open distal end. The lock is slidably receivable within a slot 224 in the manifold body 196 and a corresponding slot 228 in the manifold cover 192. The lock 220 is slidable along a width of the manifold body 196 and the manifold cover 192 along a direction perpendicular to the direction in which the manifold cover 192 is insertable into the manifold body 196. Other locks designs may be incorporated in other embodiments.

FIG. 8 illustrates a cross-sectional view of the assembled injector manifold 168 and cover 192. The O-ring seals 236 are illustrated within the cross-section at five locations. As can be seen, the integrated plug 188 prevents the flow of either supply water or regenerant brine from flowing through one of the third and fourth ports 208, 212, while the supply water is directed through the injector 172, and draws the regenerant brine in through the injector 172, and the resultant mixture is directed through the other one of the third and fourth ports 208, 212.

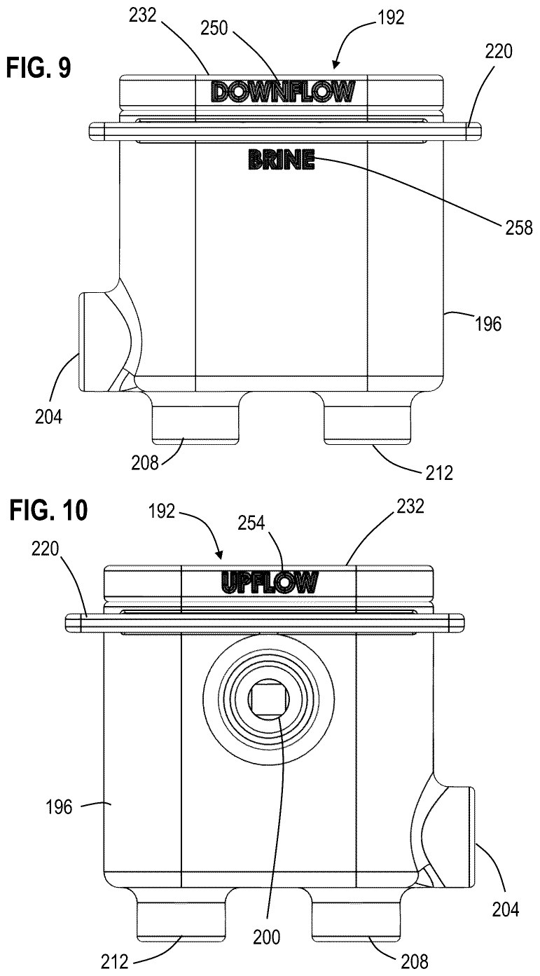

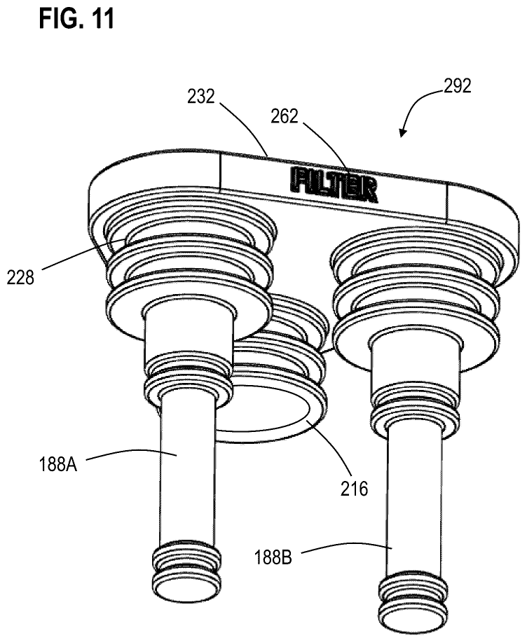

The interior of the manifold body 196 includes first and second bores (i.e., openings) 240, 244 that receive the sleeve 216 and plug 188. At least some of the O-ring seals provide a radial seal between the bores 240, 244 and the sleeve 216 and plug 188 received therein. As the bores 240, 244 of the manifold body 196 have similar diameters to one another, and the plug 188 and sleeve 216 have similar diameters to one another to each sealingly engage either one of the bores 240, 244, the cover 192 can be installed in a first orientation and subsequently removed, reversed, and reinstalled in a second orientation (e.g., by rotating the manifold cover 180 degrees about an axis parallel to the insertion direction of the plug 188 and sleeve 216 into the body 196) to change the brining direction from upflow to downflow, and vice-versa, as illustrated in FIGS. 9-10. In the first orientation, the injector 172 is positioned in a flow path between the supply water inlet port 200 and the third port 208 and the plug 188 closes a flow path between the supply water inlet port 200 and the fourth port 212. In the second orientation, the injector 172 is positioned in the flow path between the supply water inlet port 200 and the fourth port 212 and the plug 188 closes the flow path between the supply water inlet port 200 and the third port 208.

With continued reference to FIGS. 9-10, the injector manifold 168 and cover 192 deliver information to a user, installer, service personnel, etc. about the configuration of the valve 112. The information can include indicia such as indicators (e.g., arrows or other icons) or text (e.g., words and phrases) with a first indicium 250 provided on one side of the manifold cover 192, a second indicium 254 provided on an opposite side of the manifold cover 192, and a third indicium 258 provided by the manifold body 196. The content of the first and second indicia 250, 254 can be opposite one another, with one of the two indicia 250, 254 cooperating with the third indicium 258 (i.e., when aligned with the third indicium 258) to deliver information to the user. In the illustrative example, the word “BRINE” is printed, engraved, embossed, or otherwise provided as the third indicium 258 on the first side of the injector manifold 168 (FIG. 9). The word “DOWNFLOW” is printed, engraved, embossed, or otherwise provided as the first indicium 250 on the first side of the cover 192 (FIG. 9), and the word “UPFLOW” is similarly provided as the second indicium 254 on the opposing second side of the cover 192 (FIG. 10). Preferably, the first side of the injector manifold 168 and manifold cover 192 is an outwardly facing side that is most readily visible to users, installers, service personnel, etc. With the cover 192 installed as shown in FIG. 9, the manifold 168 is configured for downflow brining (i.e. the plug portion 188 of the cover 192 is inserted into the port 244 that communicates with the bottom end 110B of the media tank 108, and the injector 172 is inserted into the port 240 that communicates with the top 110A of the tank 108), and the message “DOWNFLOW BRINE” is provided by the first and third indicia 250, 258 to indicate the same. When the cover 192 is removed and reversed in order to configure the valve 112 for upflow brining, the message provided changes to “UPFLOW BRINE” by the second and third indicia 254, 258. Confusion or uncertainty about the specific configuration of the valve 112 is thereby avoided without requiring the removal of the cover 192 to visually inspect the locations of a plug 188 or injector 172.

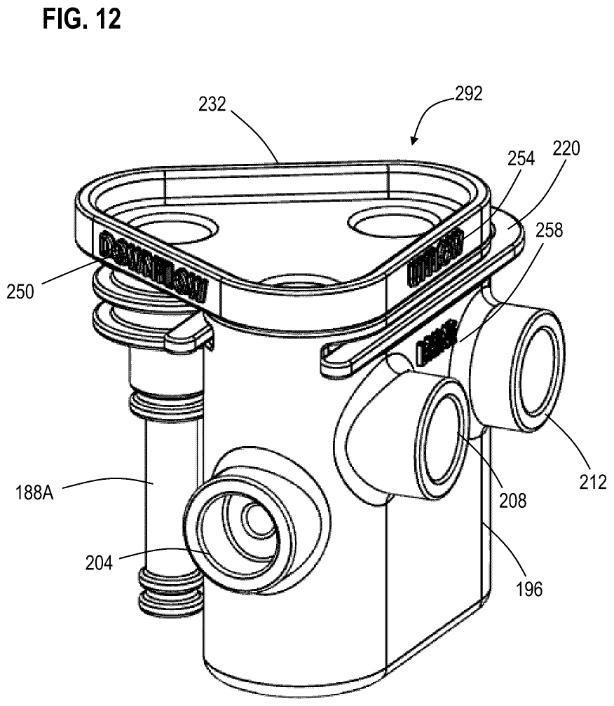

In another embodiment, as shown in FIGS. 11-12, the valve 112 can further be configured for a third mode of operation. In this third mode of operation, the control valve 112 can be used in a filtration application, wherein the valve 112 is connected to a filter such as a whole house carbon filter. Such a filtration system may require certain operations, such as for example backwashing and rinsing of the carbon media in order to remove contaminants and prepare the media for further filtration. In some embodiments, such a system does not require the brining operation associated with salt-based water softening systems. Accordingly, when the control valve 112 is to be used in such an application, it can be desirable for flow through both ports 208, 212 to be blocked.

The configuration of the valve for any one of the three modes (upflow brining, downflow brining, and filtration) can be achieved by the use of a single manifold cover 292 as shown in FIGS. 11-12. Similar to FIG. 7, the O-ring seals are omitted from FIGS. 11-12 for clarity. Additionally, the injector 172 is omitted from FIG. 11, though is received in the sleeve 216 as discussed above with respect to FIG. 7. The cover 292 includes first and second plug portions 188A, 188B, one or both of which can be inserted into the ports 240, 244 of the injector manifold 168. As the cover 292 is substantially triangular (i.e., having three outward facing sides), the two sides having “UPFLOW” and “DOWNFLOW” indicia 250, 254 are not opposite one another, but offset from one another by 120 degrees. The third side (offset from the first and second sides by 120 degrees) includes a fourth indicium 262. The word “FILTER” is printed, engraved, embossed, or otherwise provided as the fourth indicium 262 on the third side of the cover 292 (FIG. 11). In some embodiments, the third indicium 258 (on the manifold 168) may include text or icons not specific to brining such as, for example, “CONFIGURATION,” “ORIENTATION,” “READ THIS SIDE,” or an arrow.

In order to configure the valve 112 shown in FIGS. 11-12 for a filtration (i.e. no brining) application, the cover 292 is assembled to the manifold 168 such that both plug portions 188A, 188B are sealingly received within the manifold ports 240, 244, thereby blocking flow to either port 240, 244. In order to configure the valve for upflow brining or downflow brining, the cover 292 is removed, rotated, and reassembled (with 120° rotation in one direction for upflow brining, and in the other direction for downflow brining) such that one of the plug portions 188A, 188B is arranged outside of the manifold 168 and the injector 172 and sleeve 216 are instead arranged in one of the ports 240, 244. FIG. 11 illustrates the cover 292 assembled onto the manifold 168 for an upflow brining application.

As another alternative embodiment, the valve 112 can be provided with two different covers. A first cover can be the earlier-described cover 192 that allows for upflow or downflow brining, and a second cover version can be a filtration-specific cover that includes only the two plug portions 188A, 188B. A user, installer, service personnel, etc. can then install the version of the cover 192, 292 that is needed for the specific application, while preserving the benefits of providing a physical external indication of the valve configuration.

Various features of the disclosure are set forth in the following claims.

What is claimed is:

1. A control valve operable to direct a flow of pressurized water through a water treatment system having a media tank, the control valve comprising:
a body;
a supply water inlet port through which a flow of supply water is configured to enter the body;
first media tank port in communication with a top of the media tank;
a second media tank port in communication with a bottom of the media tank; and
a manifold cover removable from the body and defining a plug, an injector, and an indicium located on an exterior of the manifold cover, the manifold cover couplable to the body in at least a first orientation and a second orientation distinct from the first orientation,
wherein, in the first orientation, the injector is positioned in a flow path between the supply water inlet port and the first media tank port and the plug closes a flow path between the supply water inlet port and the second media tank port, and
wherein, in the second orientation, the injector is positioned in the flow path between the supply water inlet port and the second media tank port and the plug closes the flow path between the supply water inlet port and the first media tank port,
wherein the indicium identifies the orientation of the manifold cover relative to the body.

2. The control valve of claim 1, wherein the plug and the injector are fixedly coupled to one another such that removal of the manifold cover from the body simultaneously removes the plug and the injector from the body.

3. The control valve of claim 1, further comprising a regenerant inlet port through which a flow of regenerant is configured to enter the body.

4. The control valve of claim 3, wherein, in the first orientation, the injector is positioned in a flow path between the regenerant inlet port and the first media tank port, and, wherein, in the second orientation, the injector is positioned in a flow path between the regenerant inlet port and the second media tank port.

5. The control valve of claim 1, further comprising a piston positioned within the body and configured to translate between a first position and a second position such that when the manifold cover is in the first orientation and the second orientation, the piston, the injector, and the plug are positioned within the body.

6. The control valve of claim 1, wherein the indicium is a first indicium on a first side of the manifold cover, further comprising a second indicium on a second side of the manifold cover, the second side opposite the first side.

7. The control valve of claim 6, wherein the first indicium indicates a downflow brining operation corresponding to the first orientation, and wherein the second indicium indicates an upflow brining operation corresponding to the second orientation.

8. The control valve of claim 7, further comprising a third indicium on the body, wherein the third indicium aligns with the first indicium when the manifold cover is in the first orientation, and wherein the third indicium aligns with the second indicium when the manifold cover is in the second orientation.

9. The control valve of claim 1, wherein the first orientation is offset from the second orientation by a 180-degree rotation.

10. The control valve of claim 1, further comprising a lock configured to secure the manifold cover to the body and preclude axial removal of the manifold cover from the body.

11. The control valve of claim 10, wherein the lock is configured to slidably engage the body and the manifold cover.

12. A control valve operable to direct a flow of pressurized water through a water treatment system having a media tank, the control valve comprising:
a body;
a supply water inlet port through which a flow of supply water is configured to enter the body;
first media tank port in communication with a top of the media tank;
a second media tank port in communication with a bottom of the media tank; and
a manifold cover removable from the body and defining a plug and an injector fixedly coupled to one another, the manifold cover couplable to the body in a first orientation and in a second orientation, distinct from the first orientation,
wherein, in the first orientation, the injector is positioned in a flow path between the supply water inlet port and the first media tank port and the plug closes a flow path between the supply water inlet port and the second media tank port, and
wherein, in the second orientation, the injector is positioned in the flow path between the supply water inlet port and the second media tank port.

13. The control valve of claim 12, further comprising a regenerant inlet port through which a flow of regenerant is configured to enter the body, wherein, in the first orientation, the injector is positioned in a flow path between the regenerant inlet port and the first media tank port, and, wherein, in the second orientation, the injector is positioned in a flow path between the regenerant inlet port and the second media tank port.

14. The control valve of claim 12, wherein the body is a valve body, the control valve further comprising a piston positioned within the body.

15. The control valve of claim 12, wherein the body is a manifold body, the control valve further comprising a valve body having a piston positioned therein, wherein the manifold body is coupled to the valve body such that the first and second media tank ports are in communication with the media tank through the valve body.

16. The control valve of claim 12, further comprising a first indicium on a first side of the manifold cover and a second indicium on a second side of the manifold cover, the second side opposite the first side, and a third indicium on the body, wherein the first indicium indicates a downflow brining operation corresponding to the first orientation, wherein the second indicium indicates an upflow brining operation corresponding to the second orientation, and wherein the third indicium aligns with the second indicium when the manifold cover is in the second orientation.

17. The control valve of claim 12, wherein the plug is a first plug, the manifold cover further comprising a second plug fixedly coupled with the first plug and the injector, wherein the manifold cover is further couplable to the body in a third orientation, wherein, in the third orientation, the second plug closes the flow path between the supply water inlet port and the second media tank port and the first plug closes the flow path between the supply water inlet port and the first media tank port.

18. A manifold cover of a control valve operable to direct a flow of pressurized water through a water treatment system having a media tank, the manifold cover comprising:
an upper cover portion having an exterior surface;
at least one plug extending from and fixedly coupled to the upper cover portion, each plug of the at least one plug configured to close a flow path when received within the control valve;
an injector extending from and fixedly coupled to the upper cover portion, the injector configured to provide a flow path when received within the control valve;
wherein the injector and the at least one plug have similar diameters such that, in a first orientation, the injector is sealingly receivable within a first opening of the control valve and a plug of the at least one plug is sealingly receivable within a second opening of the control valve, and, in a second orientation, the injector is sealingly receivable within the second opening of the control valve and a plug of the at least one plug is sealingly receivable within the first opening of the water softener control valve.

19. The manifold cover of claim 18, further comprising a first indicium on a first side of the manifold cover and a second indicium on a second side of the manifold cover, the second side opposite the first side, wherein the first indicium indicates a downflow brining operation corresponding to the first orientation, wherein the second indicium indicates an upflow brining operation corresponding to the second orientation.

20. The manifold cover of claim 18, wherein the at least one plug includes a first plug and a second plug, wherein the injector, the first plug, and the second plug have similar diameters such that, in the first orientation, the injector is sealingly receivable within the first opening of the control valve and the first plug is sealingly receivable within the second opening of the control valve, and, in the second orientation, the injector is sealingly receivable within the second opening of the control valve and the second plug is sealingly receivable within the first opening of the control valve.
